(19) United States
(12) Patent Application Publication
(10) Pub. No.: US 2010/0141448 A1
(43) Pub. Date: Jun. 10, 2010

(54) SWITCH FUNCTION EQUIPPED TAG, TAG MANAGEMENT APPARATUS, TAG MANAGEMENT PROGRAM AND TAG MANAGEMENT METHOD

(75) Inventor: Norihiro Nakamura, Kawasaki (JP)

Correspondence Address: WESTERMAN, HATTORI, DANIELS & ADRIAN, LLP, 1250 CONNECTICUT AVENUE, NW, SUITE 700, WASHINGTON, DC, 20036, US

(73) Assignee: FUJITSU LIMITED, Kawasaki-shi (JP)

(21) Appl. No.: 12/702,691

(22) Filed: Feb. 9, 2010

Related U.S. Application Data
(63) Continuation of application No. PCT/JP2007/065803, filed on Aug. 13, 2007.

(51) Int. Cl. G08B 13/14

(52) U.S. Cl. 340/572.1

(57) ABSTRACT

A tag management apparatus that reads individual information on objects to be managed from an IC tag attached to each of the objects to be managed and manages the objects to be managed, the apparatus includes: a switch function equipped tag that is disposed at each of a plurality of locations where the objects to be managed are arranged and can switch at the location in response to a predetermined operation by a user between a valid state in which the switch function equipped tag can be read by a read unit and an invalid state in which the switch function equipped tag cannot be read by the read unit; and a management section that associates location information read from the switch function equipped tag with the individual information on each of the objects to be managed read out from the IC tag for management.

### CROSS-REFERENCE TO RELATED APPLICATIONS

This application is a continuation application, filed under 35 U.S.C. §111(a), of PCT Application No. PCT/JP2007/065803, filed Aug. 13, 2007, the disclosure of which is herein incorporated in its entirety by reference.

### FIELD

The present invention relates to a switch function equipped tag, a tag management apparatus, a tag management program, and a tag management method that associate an object to be managed with its location.

### BACKGROUND

There is known a technique concerning management of objects to be managed, such as articles or documents, that manages the objects to be managed by attaching IC tags storing specific information corresponding to the objects to be managed thereto and reading the attached IC tags.

Further, in an article management technique using such IC tags, there is known a tag management apparatus as illustrated in FIG. 6 that associates the objects to be managed and their locations using IC tags attached to the objects to be managed and antennas installed for each location segment (for example, refer to Patent Document 1: Japanese Laid-Open Patent Publication No. 2003-72919).

Furthermore, there is known a tag management apparatus as illustrated in FIG. 7 that associates the objects to be managed with their locations by reading IC tags attached to the objects to be managed and IC tags attached to location segments using a portable terminal device.

However, the technique of Patent Document 1 requires an antenna and its installation work for each location segment, involving high introduction cost. Accordingly, when the location needs to be segmented into smaller segments, an antenna and its installation work are correspondingly required. Further, the location is segmented based on the communication range of the antenna, so that further segmentation of the location is a difficult work.

Further, in the technique of FIG. 7, the objects to be managed and their locations are associated with each other through operation using the portable terminal device, which makes the data association task cumbersome and complicated. Further, in order to carry out a plurality of data association operations concurrently, an expensive portable terminal device is required.

### SUMMARY

According to an aspect of the invention, a tag management apparatus that reads individual information on objects to be managed from an IC tag attached to each of the objects to be managed and manages the objects to be managed, the apparatus comprising: a switch function equipped tag that is disposed at each of a plurality of locations where the objects to be managed are arranged and can switch at the location in response to a predetermined operation by a user between a valid state in which the switch function equipped tag can be read by a read unit and an invalid state in which the switch function equipped tag cannot be read by the read unit; and a management section that associates location information read from the switch function equipped tag with the individual information on each of the objects to be managed read out from the IC tag for management.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 is a view illustrating a configuration of a tag management apparatus according to an embodiment of the present invention;

FIG. 2 is a view illustrating a configuration of the switching tag of the tag management apparatus;

FIG. 3 is a view illustrating a positional relationship among readable range of the antenna, file tag, and switching tag;

FIG. 4 is a view illustrating a document management table, a rack management table, and a history management table retained by a database 61;

FIG. 5 is a flowchart of operation of taking-out and -in processing performed by the tag management apparatus of the present embodiment;

FIG. 6 is a view illustrating an example of a conventional tag management apparatus; and

FIG. 7 is a view illustrating another example of a conventional tag management apparatus.

### DESCRIPTION OF EMBODIMENT

An embodiment of the present invention will be described below with reference to the accompanying drawings.

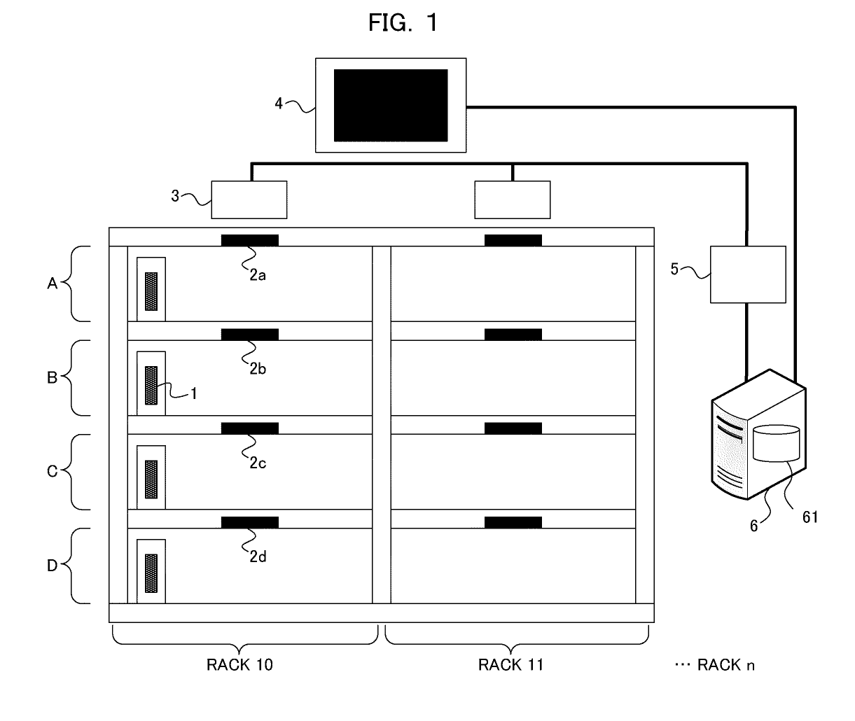

First, a configuration of a tag management apparatus according to an embodiment of the present invention will be described. FIG. 1 is a view illustrating a configuration of a tag management apparatus according to the present embodiment. In the present embodiment, an object to be managed by the tag management apparatus is assumed to be a file arranged on a rack or the like.

The tag management apparatus includes a file tag 1 (second tag), switching tags 2a to 2d (switch function equipped tags, first tags), an antenna 3 (read unit), a display 4, a reader/writer 5, a computer 6 (management section), a database 61, and a rack 10 (rack for objects to be managed). The computer 6 has hardware resources including at least a CPU (Central Processing Unit), a non-volatile storage device such as a main storage device, a magnetic storage device, and the like, an input device such as a keyboard, mouse, and the like, and an output device such as a monitor.

The racks 10 to n each have a plurality of rows. Switching tags 2a to 2d are attached respectively to the plurality of rows. In the following description of the embodiment, only the rack 10 is taken as a representative example.

The antenna 3 reads the file tag 1 and switching tags 2a to 2d. The readable range of the antenna 3 is confined to a range that the antenna 3 can read only the switching tags 2a to 2d attached respectively to the rows of the racks 10 to n.

The file tag 1 is a tag attached to the file and is a passive tag that does not require a built-in battery. The file tag 1 retains an ID (second information) which is information indicating an object to be managed. The tag set (including the switching tags 2a to 2d) is attached respectively to the racks 10 to n. The state of each tag can be switched between an invalid state in which the antenna 3 cannot read the tag and a valid state in which the antenna 3 can read the tag.

The file tag 1 is disposed at a portion where it cannot be read by the antenna 3, and switching tags 2a to 2d are disposed at portions where they can be read by the antenna 3. By increasing the number of the switching tags 2a to 2d within a range where they can be read by the antenna 3, location information can be segmented into smaller units for management.

The computer 6 has the database 61 and controls the reader/writer 5 and display 4. The database 61 retains a document management table for managing information added to the ID of the file tag 1, a rack management table for managing information added to location numbers (to be described later) of the switching tags 2a to 2d, and a history management table for managing the history of processing performed for the document management and rack management. The details of the document management table, rack management table, and history management table will be described later.

The display 4 displays, to an administrator of the racks and files, a processing result, an instruction request, and a confirmation information. The reader/writer 5 instructs the antenna 3 to read the file tag 1 and switching tags 2a to 2d. Further, the reader/writer 5 can write the ID in the file tag 1 and location numbers in the switching tags 2a to 2d.

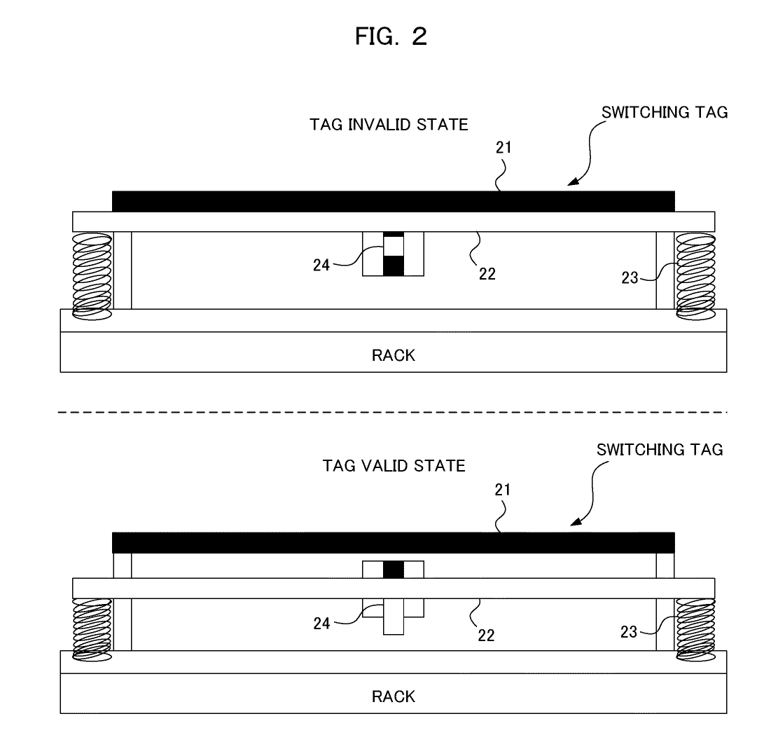

FIG. 2 is a view illustrating a configuration of the switching tag of the tag management apparatus.

The switching tags 2a to 2d each have a wireless tag 21 (IC tag), a metal plate 22 (read-blocking member), a spring 23, and a lever 24 (operation section). The wireless tag 21 is a passive tag that retains location number (first information) indicating a location. For example, the first row of the rack 10 of FIG. 1 has a location number of 10A. The metal plate 22 is tightly attached to the IC tag 21 so as to make it impossible for the antenna 3 to read the wireless tag 21. The spring 23 causes the metal plate 22 to be tightly attached to the wireless tag 21. The lever 24 separates the metal plate 22 that is tightly attached to the wireless tag 21 by the spring 23 from the wireless tag 21 so as to make it possible for the wireless tag 21 to be read by the antenna 3. In a normal state, the metal plate 22 is tightly attached to the wireless tag 21, so that the antenna 3 cannot read the wireless tag 21 and, only when the metal plate 22 is separated from the wireless tag 21 by the lever 24, the antenna 3 can read the wireless tag 21.

Like the file tag 1, the wireless tag 21 is a passive tag that does not require a power source. Thus, by tightly attaching the metal plate 22 to the passive tag which is lower in cost than an active tag to make it impossible for the antenna 3 to read the passive tag, switching between the invalid state and valid state of the wireless tag 21 can be achieved at low cost.

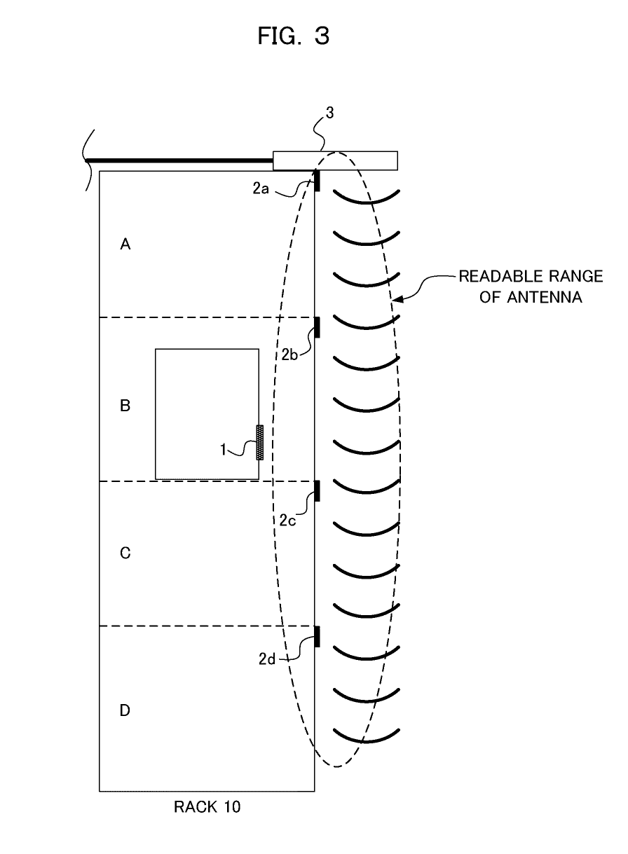

FIG. 3 is a view illustrating a positional relationship among the readable range of the antenna, file tag, and switching tag.

FIG. 3 illustrates the rack 10 of FIG. 1 as viewed from the side. The radiowave output of the antenna 3 is set by the reader/writer 5 such that the readable range of the antenna 3 covers the switching tags 2a to 2d but does not reach the file tag 1. Alternatively, a configuration may be adopted in which the switching tags 2a to 2d are directed in such a direction that the antenna 3 can read them and the file tag 1 is directed in such a direction that the antenna 3 cannot read it. Further alternatively, a configuration may be adopted in which the rack 10 is made of a material that shields the radiowave from the antenna 3 and the switching tags 2a to 2d are disposed outside the rack while the file tag 1 is disposed inside the rack.

As described above, in the present embodiment, the antenna 3 reads the tag only when one of the switching tags 2a to 2d enters the valid state or the file tag 1 exists within the readable range of the antenna 3. When the antenna 3 reads any one of the switching tags 2a to 2d and corresponding file tag 1, the computer 6 associates an object to be managed with a row of the rack.

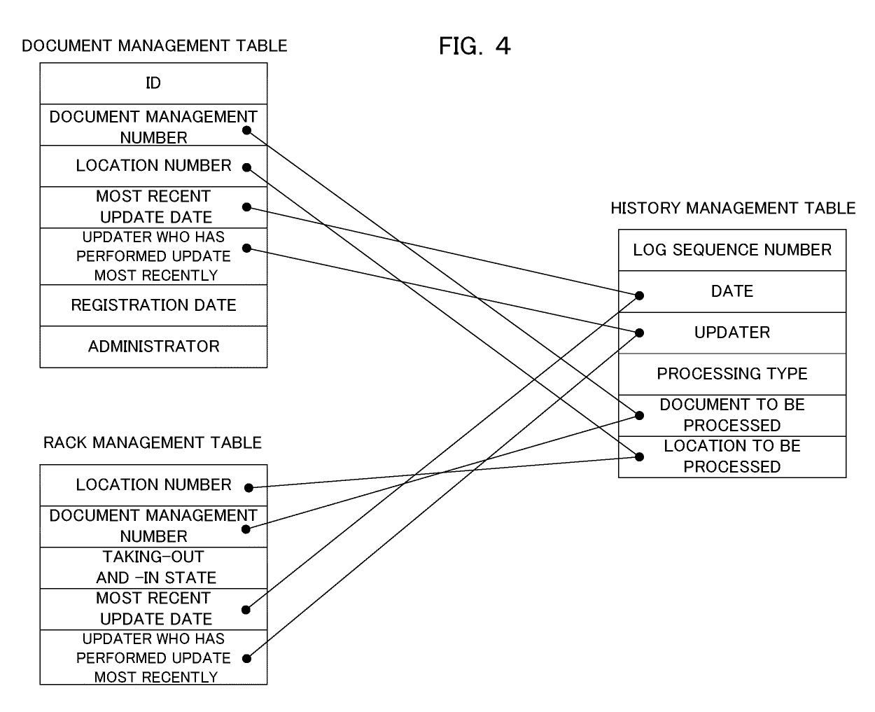

FIG. 4 is a view illustrating the document management table, rack management table, and history management table retained by the database 61.

The document management table manages, in association with one another, ID of the file tag 1 attached to the file, document management number indicating the classification of the file, location number of the switching tag, most recent update date indicating the most recent file taking-out and -in date, updater who has made taking-out and -in management most recently, registration date of a file indicated by the ID, and administrator of a file indicated by the ID. The above tables are updated at the time when the file taking-out and -in processing is performed.

The rack management table manages, in association with one another, location number of the switching tag, document management number, taking-out and -in state of a row indicated by the location number, most recent update date indicating the most recent taking-out and -in date of a file in a row indicated by the location number, and updater who has made taking-out and -in management most recently.

The history management table is information that is retained in the database 61 as a log corresponding to final processing made for the managed rack. The history management table manages, in association with one another, log sequence number indicating the order of the log, most recent update date indicating the most recent taking-out and -in date, updater who has made taking-out and -in management most recently, processing type indicating the type of processing performed most recently, document to be processed which is the document management number of a file that has been processed most recently, and location to be processed indicating the location number of a row that has been processed most recently.

In FIG. 4, the same parameters are connected by lines among the document management table, rack management table, and history management table. Thus, the above three tables are managed in association with one another, whereby it is possible to easily grasp when which file has been taken in or out from which rack.

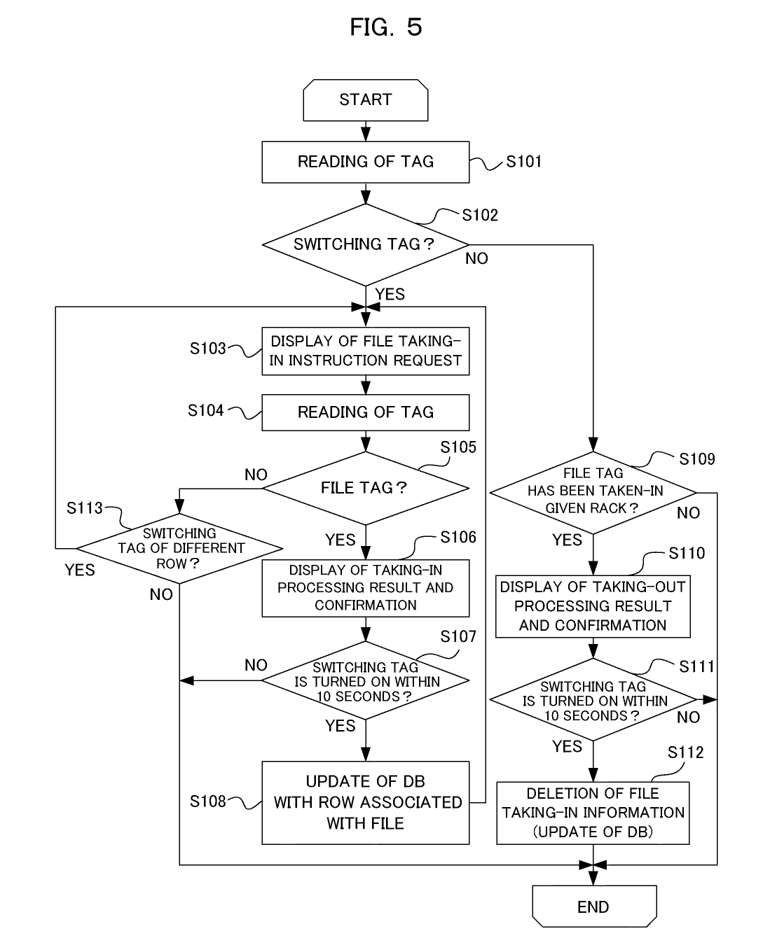

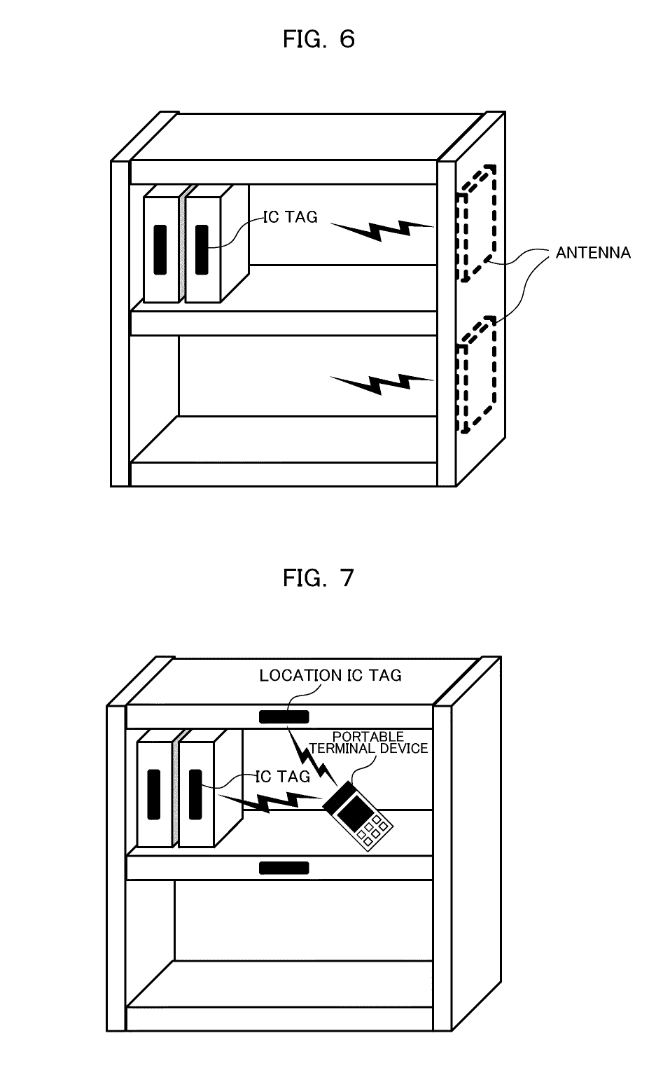

Next, operation of the tag management apparatus of the present embodiment will be described. FIG. 5 is a flowchart of operation of taking-out and -in processing of the tag management apparatus of the present embodiment. This flowchart illustrates processing performed for one rack 10, and it is assumed that the reader/writer makes the antenna read the file tag and switching tag at intervals of one second. Further, it is assumed that the switching tag read by the antenna in this flowchart is the switching tag 2b of a row B of the rack 10 of FIG. 1.

The antenna 3 reads the tag (S101), and the computer 6 that has received information on the tag determines whether the tag that has been read is one of the switching tags 2a to 2d (S102).

When determining that the tag that has been read is one of the switching tags 2a to 2d (YES in S102), the computer 6 displays a file taking-in instruction request on the display 4 (S103).

The antenna 3 then reads the tag once again (S104), and the computer 6 that has received information on the tag determines whether the tag that has been read is the file tag 1 (S105).

When determining that the tag that has been read is the file tag 1 (YES in S105), the computer 6 displays a result of the taking-in processing and an instruction for making the administrator confirm the result on the display 4 (S106). Then, the computer 6 determines whether the state of the switching tag 2b read in step S101 has been switched to the valid state within 10 seconds after the display of the taking-in processing result of step S106 (S107).

When determining that the state of the switching tag 2b has been switched to the valid state within 10 seconds (YES in S107), the computer 6 updates the database 61 with the switching tag 2b associated with the file tag 1 (S108) and displays once again the file taking-in instruction request on the display 4 (S103).

When determining in step S107 that the state of the switching tag 2b has not been switched to the valid state within 10 seconds after the display of the taking-in processing result of step S106 (NO in S107), the computer 6 determines that the taking-in processing has been canceled and ends the processing flow.

When determining in step S105 that the tag that has been read is not the file tag 1 but one of the switching tags 2a to 2d (NO in S105), the computer 6 determines whether the tag that has been read is a switching tag other than the switching tag 2b, that is, whether the read tag is a switching tag of a different row (S113).

When determining that the read tag is a switching tag of a different row (YES in S113), the computer displays once again the file taking-in instruction request on the display 4 (S103).

When determining that the read tag is the switching tag 2d (NO in S113), the computer 6 determines that the taking-in processing has been canceled and ends the processing flow.

When determining in step S102 that the read tag is not any one of the switching tags 2a to 2d but the file tag 1 (NO in S102), the computer 6 determines whether a file indicated by the read file tag 1 has been taken in a given rack (S109).

When determining that a file indicated by the read file tag 1 has been taken in a given rack (YES in S109), the computer 6 displays a result of the taking-out processing and an instruction for making the administrator confirm the result (S110). Then, the computer 6 determines whether the state of any one of the switching tags 2a to 2d has been switched to the valid state within 10 seconds after the display of the taking-out processing result of step S110 (S111).

When determining that the state of one of the switching tags 2a to 2d has been switched to the valid state within 10 seconds after the display in step S110 (YES in S111), the computer 6 deletes information corresponding to the ID retained by the file tag 1 from the document management table in the database 61 (S112).

When determining that the state of any one of the switching tags 2a to 2d has not been switched to the valid state within 10 seconds after the display of the taking-out processing result of step S110 (NO in S111), the computer 6 determines that the taking-out processing has been canceled and ends the processing flow.

When determining in step S109 that a file indicated by the file tag 1 has not been taken in a given rack (NO in S109), the computer 6 ends the taking-out processing.

With the operation described above, it is possible to associate a file to which the file tag 1 has been attached and rows to which the switching tags 2a to 2d are attached with one rack by one antenna 3. Further, the switching tags 2a to 2d can be used as input devices for the computer 6 like the operation in step S107 and step S111.

Further, it is possible to provide a program that allows a computer constituting the tag management apparatus to execute the above steps as a tag management program. By storing the above program in a computer-readable recording medium, it is possible to allow the computer constituting the tag management apparatus to execute the program. The computer-readable recording medium mentioned here includes: an internal storage device mounted in a computer, such as ROM or RAM, a portable recording medium such as a CD-ROM, a flexible disk, a DVD disk, a magneto-optical disk, or an IC card; a database that holds computer program; another computer and database thereof; and a transmission medium on a network line.

As described above, it is possible to achieve, at low cost, efficient data association task and further segmentation of the location.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiment(s) of the present inventions have been described in detail, it should be understood that the various changes, substitutions, and alterations could be made hereto without departing from the spirit and scope of the invention.

What is claimed is:

1. A tag management apparatus that reads individual information on objects to be managed from an IC tag attached to each of the objects to be managed and manages the objects to be managed, the apparatus comprising:
a switch function equipped tag that is disposed at each of a plurality of locations where the objects to be managed are arranged and can switch at the location in response to a predetermined operation by a user between a valid state in which the switch function equipped tag can be read by a read unit and an invalid state in which the switch function equipped tag cannot be read by the read unit; and
a management section that associates location information read from the switch function equipped tag with the individual information on each of the objects to be managed read out from the IC tag for management.

2. The tag management apparatus according to claim 1, wherein
the switch function equipped tag comprising:
an IC tag that has an antenna and retains predetermined information in a readable manner by the read unit;
a read-blocking member that is brought close to the IC tag so as to makes it impossible for the read unit to read the predetermined information; and
an operation section that separates the read-blocking member away from the IC tag so as to make it possible for the read unit to read the predetermined information.

3. The tag management apparatus according to claim 1, wherein
the objects to be managed to which the IC tags are attached are arranged in respective locations such that the read unit cannot read the IC tags.

4. The tag management apparatus according to claim 1, further comprising a storage rack for object to be managed having a plurality of rows corresponding to the plurality of locations at which the switch function equipped tags are disposed.

5. A tag management apparatus comprising:
a switch function equipped first tag that retains first information and can switch in response to a predetermined operation by a user between a valid state in which the first tag can be read by a read unit and an invalid state in which the first tag cannot be read by the read unit;
a second tag that retains second information in a readable manner by the read unit; and
a management section that associates the first information read from the first tag with the second information read from the second tag for management.

6. The tag management apparatus according to claim 5, wherein,
when the first information is read from the first tag, the management section reads the second information from the second tag and associates the first and second information with each other for management.

7. The tag management apparatus according to claim 6, wherein
after the first and second information are read, the management section associates the first and second information with each other for management on the condition that the first information is read within a predetermined time period.

8. A switch function equipped tag comprising:
an IC tag that has an antenna and retains predetermined information in a readable manner by the read unit;
a read-blocking member that is brought close to the IC tag so as to makes it impossible for the read unit to read the predetermined information; and
an operation section that separates the read-blocking member away from the IC tag so as to make it possible for the read unit to read the predetermined information.

9. The switch function equipped tag according to claim 8, wherein
the read-blocking member is made of a metal material or magnetic material to be biased to the IC tag.

10. The switch function equipped tag according to claim 8, wherein
the switch function equipped tag retains information concerning one location of each of a plurality of objects to be managed to which a plurality of IC tags are attached.

11. A tag management method comprising:
determining whether first information is read from a switch function equipped first tag that can switch in response to a predetermined operation by a user between a valid state in which the first tag can be read by a read unit and an invalid state in which the first tag cannot be read by the read unit; and
managing by associating second information read from a second tag with the first information, when the determining determines that the first information is read.

12. The tag management method according to claim 11, wherein,
when the determining determines that the first information is read, the managing reads the second information from the second tag and associates the read second information with the first information for management.

13. The tag management method according to claim 11, wherein
after the first and second information are read, the managing associates the first and second information with each other for management on the condition that the first information is read within a predetermined time period.

14. The tag management method according to claim 11, wherein
the first tag is disposed at the location at which an object to be managed is arranged,
the first information is position information on the object to be managed,
the second tag is attached to the object to be managed, and
the second information is individual information on the object to be managed.

15. An IC tag switching method that has an antenna and retains predetermined information in a readable manner by a read unit, wherein
a read-blocking member made of a metal material or magnetic material is provided so as to freely be brought close to and separated away from the IC tag, and
bringing the read-blocking member close to the IC tag disables reading of the predetermined information from the IC tag; while separating the read-blocking member away from the IC tag enables reading of the predetermined information from the IC tag.

16. The IC tag switching method according to claim 15, wherein
the read-blocking member is held in a state of being close to the IC tag, and
the lead-blocking member is separated away from the IC tag so as to enable reading of the predetermined information from the IC tag.

17. A computer-readable recording medium that stores a tag management program allowing a computer to execute a process of managing an object to be managed through management of tag information, wherein
the process comprises:
determining whether first information is read from a switch function equipped first tag that can switch in response to a predetermined operation by a user between a valid state in which the first tag can be read by a read unit and an invalid state in which the first tag cannot be read by the read unit; and
managing by associating second information read from a second tag with the first information, when the determining determines that the first information is read.

18. The computer-readable recording medium according to claim 17, wherein,
when the determining determines that the first information is read, the managing allows the computer to read the second information from the second tag and associate the read second information with the first information for management.

19. The computer-readable recording medium according to claim 17, wherein
after the first and second information are read, the managing allows the computer to associate the first and second information with each other for management on the condition that the first information is read within a predetermined time period.

20. The computer-readable recording medium according to claim 17, wherein
the first tag is disposed at the location at which an object to be managed is arranged,
the first information is position information on the object to be managed,
the second tag is attached to the object to be managed, and
the second information is individual information on the object to be managed.
